(19) United States
(12) Patent Application Publication
(10) Pub. No.: US 2005/0277446 A1
(43) Pub. Date: Dec. 15, 2005

(54) Wireless earphone enabling a ringing signal and method for controlling the ringing signal

(75) Inventor: Wen-Hsiang Yueh, Taipei County (TW)

Correspondence Address: BACON & THOMAS, PLLC, 625 SLATERS LANE, FOURTH FLOOR, ALEXANDRIA, VA, 22314, US

(73) Assignee: Partner Tech. Corporation, Taipei County (TW)

(21) Appl. No.: 11/147,281

(22) Filed: Jun. 8, 2005

(30) Foreign Application Priority Data
Jun. 9, 2004 (TW) 93116549

(51) Int. Cl. H04Q 7/20

(52) U.S. Cl. 455/569.1

(57) ABSTRACT

This invention provides a wireless earphone able to control a ringing signal in response to an incoming call. This invention particularly provides a wireless earphone enabling the volume of the ringing signal relied on the status of the wireless earphone. The wireless earphone depends on an ear-hook action of the earphone or a sensor detecting the ear-hook action to determine the status of the earphone to control the volume of the ringing signal. As such, when the wireless earphone is not in use, i.e. being not worn, the volume of the ringing signal is enlarged to make the user perceives an incoming call. When the wireless earphone is in use, i.e. being worn, the volume of the ringing signal is in a range meeting a safety specification. The hearing of the user thus can be protected.

### BACKGROUND OF THE INVENTION

1. Field of the Invention

The present invention relates to a wireless earphone, and more particularly to a wireless earphone enabling the volume of a ringing signal relied on an ear-hook action of the earphone or a sensor detecting the ear-hook action.

2. Description of the Related Art

As technology advances, 3C communication grows and the convenience of electronic communication devices increases, people using mobile phones would like to use a wireless earphone and a microphone as media for communication. As a result, there are many wireless earphones with different functions and versatile styles available in the market. Each wireless earphone is focused on the designs of style, color, volume and weight etc.

Nowadays, for convenience, most people put their mobile phones in a suitcase or a backpack and use a wireless earphone to answer an incoming call and talk with the speaker. Once the talk is over, the wireless earphone is taken off and put at a place reachable for the user, such as a pocket of the user, while is not always worn on the ear.

However, once another incoming call comes and the wireless earphone is put somewhere not worn on the ear, the volume of ringing of the incoming call may be too small to be heard by the user. The user probably misses the incoming call.

To resolve the above problem, it is desirable to separate the ringing signal of the incoming call to two different sections, in which the ringing signal with a relatively small volume is suitable for the user who is wearing the wireless earphone to hear the incoming call in a near distance. As to the ringing signal with a relatively large volume, it is suitable for the user who puts the wireless earphone in somewhere while not wears it in order that the user can hear the incoming call.

### SUMMARY OF THE INVENTION

It is one objective of the present invention to provide a wireless earphone enabling the volume of a ringing signal in response to an incoming call relied on whether the earphone is in use.

It is another objective of the present invention to provide a wireless earphone enabling the volume of a ringing signal to become small by sensing an ear-hook action of the earphone.

It is still another objective of the present invention to provide a wireless earphone enabling the volume of a ringing signal to become small by a sensor detecting the status of the earphone.

It is a further objective of the present invention to provide a method for controlling a ringing signal in response to an incoming call relied on the status of the earphone.

In one preferred embodiment of the present invention, the wireless earphone includes a main body, an earphone and an ear-hook member. The main body has a boom extension with a microphone disposed at a distal end. The earphone is disposed at an inner side of the main body. The ear-hook member is pivotably connected with the main body. The wireless earphone is characterized in the motion of the ear-hook member can drive a micro-switch to enable the volume of the ringing signal to become small.

The ear-hook member is pivotably connected with the main body via a pivotal connection member. The pivotal connection member and the micro-switch move cooperatively such that the action of the ear-hook member can drive the micro-switch via the pivotal connection member so as to enable the volume of the ringing signal to become small.

In one another preferred embodiment of the present invention, the wireless earphone includes a main body, an earphone and an ear-hook member. The main body has a boom extension with a microphone disposed at a distal end. The earphone is disposed in an inner side of the main body. The ear-hook member is pivotably connected with the main body. The wireless earphone is characterized in that the main body is disposed with a sensor proximate to the earphone. The sensor detects the status of the wireless earphone and enables the volume of the ringing signal to become small.

### BRIEF DESCRIPTION OF THE DRAWINGS

FIG. 1 shows a use state of a wireless earphone according to a first embodiment of the present invention;

FIG. 2 shows a use state of a variance of the wireless earphone of FIG. 1; and

FIG. 3 shows a use state of a wireless earphone according to a second embodiment of the present invention.

### DETAILED DESCRIPTION OF THE PREFERRED EMBODIMENTS

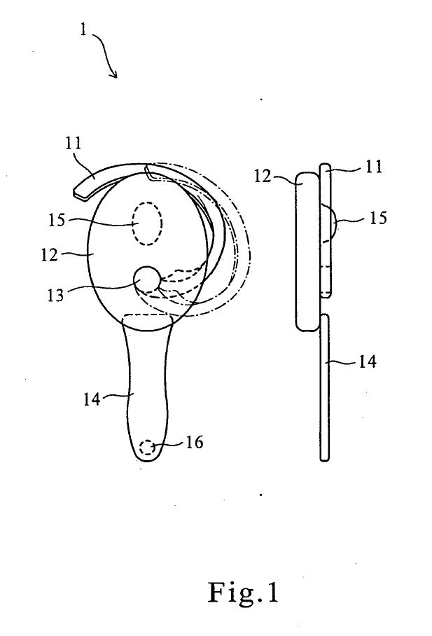

Please refer to FIG. 1, which shows the use state of the wireless earphone 1 according to a first embodiment of the present invention. The ear-hook member 11 drawn in solid line represents the wireless earphone 1 is not in use state, i.e. the earphone is not worn on the user. The ear-hook member 11 drawn in dotted line represents the wireless earphone 1 is in use state, i.e. the earphone is worn on the user. The main body 12 of the wireless earphone 1 encloses a circuit board (not shown). It is well known for skilled artisans in the art that the circuit board practices functions of the wireless earphone 1 and generates a ringing signal in earphone 15 responding to an incoming call.

In the first embodiment of the present invention, when the wireless earphone 1 is not worn on the user, the wireless earphone 1 generates a first-section ringing signal in response to an incoming call. When the user desires to wear the wireless earphone 1, the user needs to rotate the ear-hook member 11 a certain angle so that the ear-hook member 11 reaches the dotted-line position. Then, the wireless earphone 1 can be worn on the ear of the user. Owing to rotating the ear-hook member 11, the first-section ringing signal is automatically switched to a second-section ringing signal. The volume of the second-section ringing signal is smaller than that of the first-section ringing signal. To protect the hearing of the user, the volume of the second-section ringing signal is more suitable for the user who is wearing the wireless earphone 1 or in a range meeting a safety specification. Once the user is wearing the wireless earphone 1, the user can hear the incoming call and talk with the speaker through the microphone 16.

The ear-hook member 11 is a curved piece and pivotably connected with the main body 12 via a pivotal connection member 13. The position of the ear-hook member 11 is rotationally adjusted with the pivotal connection member 13 as a shaft. The pivotal connection member 13 and a micro-switch (not shown) cooperatively move and the micro-switch is realized in the circuit board enclosed in the main body 12. The micro-switch works together with the circuit generating a ringing signal in response to an incoming call. The action of the micro-switch enables the volume of the ringing signal to become small. That is, the micro-switch switches the first-section ringing signal and second-section ringing signal. In the first embodiment, the rotation of the ear-hook member 11 drives the pivotal connection member 13 and micro-switch to cooperatively move to facilitate the micro-switch to switch the volume of the ringing signal.

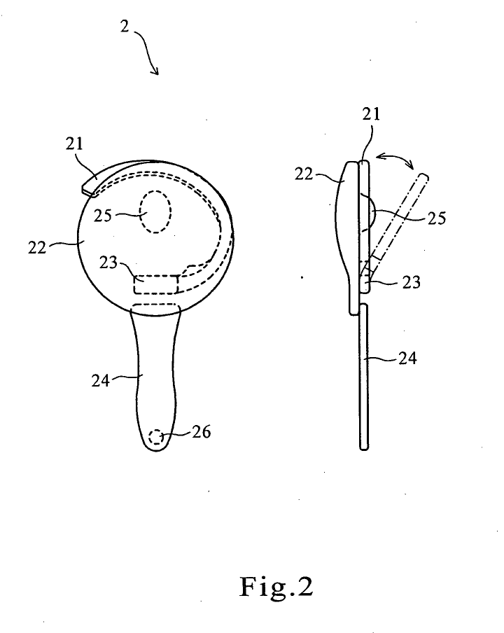

Please refer to FIG. 2, which shows a use state of a variance of the wireless earphone of the first embodiment of the present invention. The wearing fashion of the ear-hook member 21 is different. The ear-hook member 21 drawn in solid line represents the wireless earphone 2 is not in use state, i.e. not worn on the user. The ear-hook member 21 drawn in dotted line represents the wireless earphone 2 is in use state, i.e. worn on the user.

In this variance, when the wireless earphone 2 is not worn on the user, the wireless earphone 2 generates a first-section ringing signal in response to an incoming call. When the user desires to wear the wireless earphone 2, the user needs to swingingly rotate the ear-hook member 21 a certain angle to reach the dotted-line position, and then the wireless earphone 2 can be worn on the ear of the user. Owing to swingingly rotate the ear-hook member 21, the wireless earphone 2 automatically switches to the second-section ringing signal. The volume of the second-section ringing signal is smaller than that of the first-section ringing signal. To protect the hearing of the user, the volume of the second-section ringing signal is more suitable for the user who is wearing the wireless earphone 2 or in the range meeting the safety specification.

The ear-hook member 21 is a curved piece and pivotably connected with the main body 22 via a pivotal connection member 23. The ear-hook member 21 is swingingly moved with the pivotal connection member 23 as a shaft. The pivotal connection member 23 and a micro-switch (not shown) cooperatively move and the micro-switch is realized in the circuit board enclosed in the main body 22. The micro-switch works together with the circuit generating a ringing signal in response to an incoming call. The micro-switch enables the volume of the ringing signal to become small. That is, the micro-switch switches the first-section ringing signal and second-section ringing signal. In this embodiment, the rotation of the ear-hook member 21 drives the pivotal connection member 23 and micro-switch to cooperatively move to facilitate the micro-switch to switch the volume of the ringing signal.

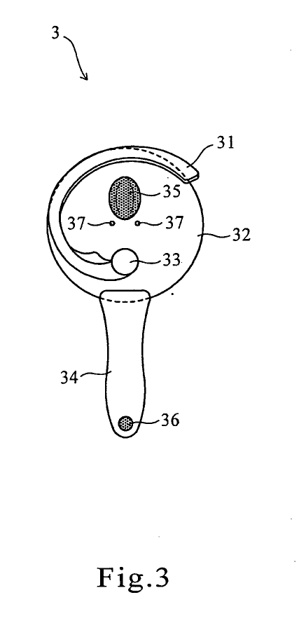

Please refer to FIG. 3, which shows a use state of the wireless earphone 3 according to a second embodiment of the present invention. A sensor 37 is disposed proximate to an earphone 35 disposed in an inner side of the main body 32 or a pivotal connection member 33. The sensor 37 can be an infrared device and realized in a circuit board enclosed in the main body 32. The sensor 37 works together with the circuit generating a ringing signal in response to an incoming call. In the second embodiment, the sensor 37 switches the volume of the ringing signal.

In the second embodiment, when the wireless earphone 3 is not worn on the user, the wireless earphone 3 generates a first-section ringing signal in response to an incoming call. When the wireless earphone 3 is worn on the ear of the user, the sensor 37 can detect the wireless earphone 3 having been worn. As such, the wireless earphone 3 automatically switches to the second-section ringing signal. The volume of the second-section ringing signal is smaller than that of the first-section ringing signal. To protect the hearing of the user, the volume of the second-section ringing signal is more suitable for the user who is wearing the wireless earphone 3 or in a range meeting a safety specification.

In the above embodiments, when the user keeps wearing the wireless earphone and an incoming call comes, since the ear-hook member 11 is in a rotated or swung state, or the sensor 37 detects the wireless earphone 3 having been worn on the ear of the user, the wireless earphone generates the second-section ringing signal but not the first-section ringing signal. The volume of the second-section ringing signal is suitable for the user who is wearing the wireless earphone to hear the ringing through the earphone in a very near distance. Therefore, even the user is not in talk with the wireless earphone, the user also can wear the wireless earphone and does not worry about the volume of the ringing signal in response to an incoming call would damage the hearing.

In addition, when the wireless earphone is taken off and put in a pocket of the user, the wireless earphone will return to the first-section ringing signal in response to an incoming call, and the user does not worry about he/her can not hear the ringing since the volume of the ringing signal is louder.

In accordance with the above embodiments, the method for controlling a ringing signal of the present invention is practiced in a wireless earphone. The wireless earphone generates a ringing signal in response to an incoming call. The present method determines the volume of the ringing signal relied on whether the wireless earphone is worn on the user. The process for judging whether the wireless earphone is worn including the step of using the micro-switch to detect whether the ear-hook member has been rotated or swung owing to that the ear-hook member is worn on the ear or using a sensor disposed proximate to the earphone to detect the status of the wireless earphone. The present method includes determining the volume of the ringing signal, i.e. switching the first-section ringing signal or the second-section ringing signal, by judging whether the wireless earphone is worn or not.

Although the present invention has been described in detail with reference to certain embodiments thereof, those skilled in the art can easily understand that all kinds of alterations and changes can be made within the spirit and scope of the appended claims. Therefore, the spirit and scope of the appended claims should not be limited to the description of the embodiments contained herein.

1. A wireless earphone, comprising:
a main body having a boom extension, said boom extension disposed with a microphone at a distal end;
an earphone disposed at an inner side of said main body; and
an ear-hook member pivotably connected with said main body;
which is characterized in: the motion of said ear-hook member drives a micro-switch to enable the volume of a ringing signal to become small.

2. The wireless earphone as defined in claim 1, wherein said ear-hook member is a curved piece.

3. The wireless earphone as defined in claim 1, further comprising a pivotal connection member by which said ear-hook member pivotably connected with said main body, and said pivotal connection member and said micro-switch cooperatively move.

4. The wireless earphone as defined in claim 3, wherein said ear-hook member rotationally moves with said pivotable connection member as a shaft.

5. The wireless earphone as defined in claim 3, wherein said ear-hook member swingingly moves with said pivotably connection member as a shaft.

6. The wireless earphone as defined in claim 1, wherein said ear-hook member rotationally moves to enable the volume of the ringing signal to become small.

7. The wireless earphone as defined in claim 4, wherein said ear-hook member rotationally moves to enable the volume of the ringing signal to become small.

8. The wireless earphone as defined in claim 1, wherein said ear-hook member swingingly moves to enable the volume of the ringing signal to become small.

9. The wireless earphone as defined in claim 5, wherein said ear-hook member swingingly moves to enable the volume of the ringing signal to become small.

10. A wireless earphone, comprising:
a main body having a boom extension, said boom extension disposed with a microphone at a distal end;
an earphone disposed at an inner side of said main body; and
an ear-hook member pivotably connected with said main body;
which is characterized in: said main body is disposed with a sensor proximate to said earphone, said sensor detects the status of said wireless earphone and enables the volume of a ringing signal to become small.

11. The wireless earphone as defined in claim 10, wherein said ear-hook member is a curved piece.

12. The wireless earphone as defined in claim 10, wherein said sensor is an infrared device.

13. A method for controlling a ringing signal implemented in a wireless earphone, said method comprising generating a ringing signal in response to an incoming call, which is characterized in: said wireless earphone generates a first-section ringing signal in response to the incoming call when said wireless earphone is unworn; and said wireless earphone generates a second-section ringing signal in response to the incoming call when said wireless earphone is worn, the volume of said second-section ringing signal is smaller than that of said first-section ringing signal.

14. A method for controlling a ringing signal implemented in a wireless earphone, said method comprising generating a ringing signal in response to an incoming call, which is characterized in: determining the volume of the ringing signal relied on whether said wireless earphone is worn or not.
